(19) United States
(12) Patent Application Publication
(10) Pub. No.: US 2025/0267617 A1
(43) Pub. Date: Aug. 21, 2025

(54) IMPROVEMENT OF RELOCATION WITH DEDICATED RELOCATION INFORMATION

(71) Applicant: Lenovo (Beijing) Limited, Beijing (CN)

(72) Inventors: Tingfang Tang, Beijing (CN); Haiyan Luo, Shanghai (CN)

(73) Assignee: Lenovo (Beijing) Limited, Beijing (CN)

(21) Appl. No.: 18/858,374

(22) PCT Filed: Apr. 22, 2022
(86) PCT No.: PCT/CN2022/088603

§ 371 Date: Oct. 21, 2024

(51) Int. Cl. H04W 64/00; H04L 61/4511; H04W 40/20

(52) U.S. Cl. CPC H04W 64/00; H04L 61/4511; H04W 40/20

(57) ABSTRACT

Method and apparatus for improvement of relocation with dedicated relocation information are disclosed. A Session Management Function (SMF) comprises a transceiver; and a processor coupled to the transceiver, wherein the processor is configured to receive, via the transceiver, dedicated relocation information for a specific application and targeting a collection of UEs from AF or dedicated relocation information for a specific application and targeting a specific UE belonging to the collection of UEs from PCF, wherein, the dedicated relocation information is used for routing decision for traffic and/or DNS handling decision for the specific application for each UE within the collection of UEs.

### FIELD

The subject matter disclosed herein generally relates to wireless communications, and more particularly relates to improvement of relocation with dedicated relocation information.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), data network (DN), DN Access Identifier (DNAI), 5G core (SGC), User Plane Function (UPF), Edge Application Server (EAS), data network access identifier (DNAI), PDU Session Anchor (PSA), Domain Name System (DNS), Session Management Function (SMF), Application Function (AF), Protocol Data Unit (PDU), Policy Control Function (PCF), Network Exposure Function (NEF), Policy and Charging Control (PCC), uplink classifier (UL classifier or ULCL), Service and Session Continuity (SSC), Edge Data Network (EDN), Quality of Service (QOS), Branching Point (BP), Edge Application Server Discovery Function (EASDF), Session Management (SM), Unified Data Repository (UDR).

Influencing UPF and EAS (re) location for a collection of UEs are being discussed. An example is illustrated in FIG. 1. It is assumed that a collection of UEs (e.g. UE1, UE2, UE3, . . . ) are accessing a match of the stateful online multiplayer game. It is preferable that the players (i.e. the collection of UEs) within the match can be served by the same server(s) within the same local part of DN, so that the cost of the server(s) can be saved and the efficiency of the server(s) can be leveraged. As illustrated in FIG. 1, when a first player (e.g. UE1) initiates a match, a serving server (e.g. EAS11 for application App1) is discovered and EAS11 is within a local part of DN (e.g. the local part of DN that is composed of EAS11, EAS12 and EAS13), and the local part of DN is associated with DNAI1 (e.g. accessed from DNAI1). It is preferable that the teammates and opponents (e.g. UE2, UE3) within the match are served by (e.g. connected to) the serving server (i.e. EAS11) or servers within the same local part of DN as EAS11 (or servers that are associated with the same DNAI as EAS11) to avoid interaction between different servers (e.g. between different servers at different locations e.g. associated with different DNAIs, e.g. between EAS11 associated with DNAI1 and EAS21 associated with DNAI2) during play.

According to prior art, the server discovered by a teammate (e.g. UE2) may be EAS21 associated with DNAI2, while the server discovered by an opponent (e.g. UE3) may be EAS31 associated with DNAI3. In order to ensure that all UEs (e.g. a collection of UEs) accessing the same match are served by the same server(s) within the same local part of DN or associated with the same DNAI (e.g. accessed from the same UPF PSA (e.g. UFP PSA 1 in FIG. 1)), it is necessary to improve the EAS discovery and re-discovery for the collection of UEs.

The purpose of the present invention is to improve relocation of UPFs and EAS(s) for a collection of UEs.

### BRIEF SUMMARY

Method and apparatus for improve relocation of UPFs and EAS(s) for a collection of UEs are disclosed.

In one embodiment, an application function (e.g. AF) comprises a transceiver; and a processor coupled to the transceiver, wherein the processor is configured to transmit, via the transceiver, dedicated relocation information for a specific application and targeting a collection of user equipments (UEs), to a policy control function or a session management function, wherein, the dedicated relocation information is used for routing decision for traffic and/or DNS handling decision for the specific application for each UE within the collection of UEs

In some embodiment, the dedicated relocation information is a target data network access identifier (DNAI) or a target application server. In some embodiment, the dedicated relocation information is transmitted to the session management function using a procedure for EAS deployment information management per node.

In some embodiment, the processor is configured to transmit, via the transceiver, a group ID or specific service information to identify the collection of UEs for the specific application, and transmit, via the transceiver, the dedicated relocation information for a specific UE belonging to the collection of UEs. In some embodiment, the processor is configured to transmit, via the transceiver, a group ID or specific service information to identify the collection of UEs, and the dedicated relocation information for the application and targeting the collection of UEs.

In another embodiment, a policy control function (e.g. PCF) comprises a transceiver; and a processor coupled to the transceiver, wherein the processor is configured to receive, via the transceiver, dedicated relocation information for a specific application and targeting a collection of UEs, from an application function, wherein, the dedicated relocation information is used for routing decision for traffic and/or DNS handling decision for the specific application for each UE within the collection of UEs.

In some embodiment, the processor is further configured to transmit, via the transceiver, the dedicated relocation information for the specific application and targeting a specific UE belonging to the collection of UEs to a session management function by using a policy and charging control rule. In some embodiment, the processor is configured to receive, via the transceiver, a group ID or specific service information to identify the collection of UEs, and receive, via the transceiver, the dedicated relocation information for a specific UE belonging to the collection of UEs. In some embodiment, the processor is configured to receive, via the transceiver, a group ID or specific service information to identify the collection of UEs, and the dedicated relocation information for the application and targeting the collection of UEs.

In some embodiment, the dedicated relocation information is a target data network access identifier (DNAI) or a target application server. In some embodiment, the processor is further configured to determine that a UE belongs to the collection of UEs if the UE is within a group of UEs identified by a predetermined group ID, or the UE is within a group of UEs sharing the same specific service information. In some embodiment, the processor is further configured to store the dedicated relocation information in the policy control function or a unified data repository (e.g. UDR).

In yet another embodiment, a session management function (e.g. SMF) comprises a transceiver; and a processor coupled to the transceiver, wherein the processor is configured to receive, via the transceiver, dedicated relocation information for a specific application and targeting a collection of UEs or dedicated relocation information for a specific application and targeting a specific UE belonging to the collection of UEs, wherein, the dedicated relocation information is used for routing decision for traffic and/or DNS handling decision for the specific application for each UE within the collection of UEs.

In some embodiment, the processor is further configured to control traffic routing and/or Domain Name System (DNS) handling decision for UEs belonging to the collection of UEs according to the dedicated relocation information. In particular, to control traffic routing comprises at least one of inserting a branching point (e.g. BP) and a user plane function (e.g. L-UPF) and updating a central user plane function (e.g. C-UPF). In some embodiment, the dedicated relocation information for the specific application and targeting a collection of UEs is received from an application function using a procedure for EAS deployment information management per node.

In some embodiment, the dedicated relocation information for the specific application and targeting the specific UE is received from a policy control function using a policy and charging control rule. In some embodiment, the processor is further configured to determine that a UE belongs to the collection of UEs if the UE is within a group of UEs identified by a predetermined group ID, or the UE is within a group of UEs sharing the same specific service information. In some embodiment, the processor is further configured to store the dedicated relocation information in the session management function or a unified data repository.

In one embodiment, a method performed at an application function comprises transmitting dedicated relocation information for a specific application and targeting a collection of UEs to a policy control function (PCF) or a session management function (SMF), wherein, the dedicated relocation information is used for routing decision for traffic and/or DNS handling decision for the specific application for each UB within the collection of UEs.

In another embodiment, a method performed at a policy control function comprises receiving dedicated relocation information for a specific application and targeting a collection of UEs from an application function, wherein, the dedicated relocation information is used for routing decision for traffic and/or DNS handling decision for the specific application for each UE within the collection of UEs.

In yet another embodiment, a method performed at an session management function comprises receiving dedicated relocation information for a specific application and targeting a collection of UEs or dedicated relocation information for a specific application and targeting a specific UE belonging to the collection of UEs, wherein, the dedicated relocation information is used for routing decision for traffic and/or DNS handling decision for the specific application for each UE within the collection of UEs.

### BRIEF DESCRIPTION OF THE DRAWINGS

A more particular description of the embodiments briefly described above will be rendered by referring to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of a collection of UEs accessing the same server;

FIG. 2 illustrates a first embodiment;

FIG. 3 illustrates a second embodiment;

FIG. 4 illustrates a third embodiment;

FIG. 5 illustrates a fourth embodiment;

FIG. 6 is a schematic flow chart diagram illustrating one method;

FIG. 7 is a schematic flow chart diagram illustrating another method;

FIG. 8 is a schematic flow chart diagram illustrating yet another method; and

FIG. 9 is a schematic block diagram illustrating an apparatus according to one embodiment.

### DETAILED DESCRIPTION

As will be appreciated by one skilled in the art that certain aspects of the embodiments may be embodied as a system, apparatus, method, or program product.

Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The service provider deploys the service, i.e. the application (e.g. the stateful online multiplayer game), into the application server within the edge DN (local part of the DN or local access of the DN) and/or the central DN. The AF can get the traffic routing information for the deployed application, e.g. when a UE initiates a match of the game or joint the match of the game. The application server is the server where the application is deployed. The application location can be the application location associated with the DNAI(s) e.g. which is called EAS DNAI as specified in 3GPP TS 23.558, or it can be the IP range of the part of DN deployed with the application.

As described in the background part, a collection of UEs, e.g. the players within a match of the stateful online multiplayer game, are necessary to access the same server(s) within the same local part of DN or the same server(s) associated with the same DNAI to save the cost of the server and leverage the efficiency of the server.

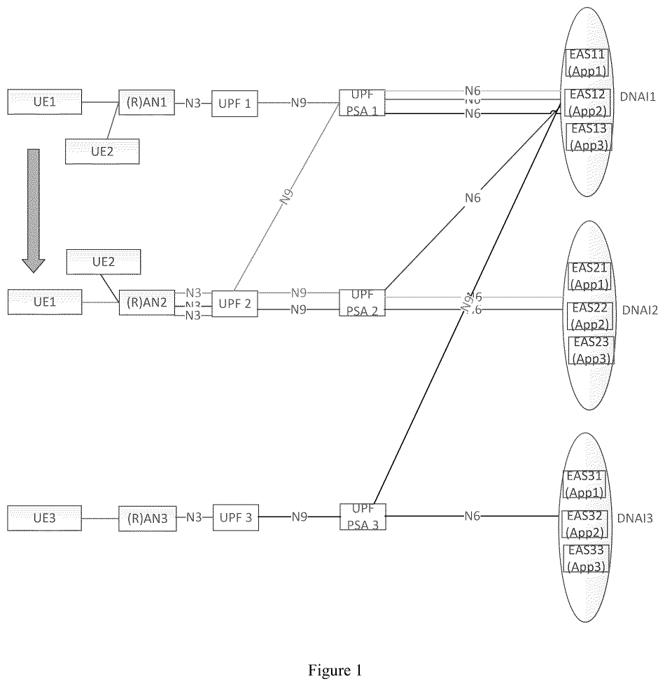

So, the collection of UEs, that are associated together under certain condition, e.g. during one match of the stateful online multiplayer game, shall be configured with dedicated relocation information, which can be for example the same DNAI (associated with the same server(s)) or the same server (i.e. same EAS). In the following description, the server and the EAS have the same meaning. It means that, when the collection of UEs access the same application (e.g. join a match of the stateful online multiplayer game), the collection of UEs can be served by the same server(s) (e.g. the same server(s) associated with the same DNAI) according to the dedicated relocation information. To be more specific, the collection of UEs shall access the application (e.g. join a match of the stateful online multiplayer game) via the same server(s) (e.g. the same server(s) associated with the same DNAI). For example, the traffic of a specific application (e.g. one match of the stateful online multiplayer game, e.g. Appl in FIG. 1) for the collection of the UEs shall be routed from/to the same UPF PSA (e.g. UPF PSA 1 in FIG. 1) so that the collection of the UEs can be served by the same server(s) within the same local part of DN or the same server(s) associated with the same DNAI (e.g. DNAI1) for the specific application (e.g. EAS11 in FIG. 1). For another example, the traffic of an application (e.g. one match of the stateful online multiplayer game) from the collection of the UEs can be directly routed to the same server (e.g. EAS11).

According to this disclosure, the dedicated relocation information is provisioned to the SMF for a collection of UE(s), e.g. for a specific application. The dedicated relocation information is used for the routing decisions for traffic and/or the DNS handling decision for each UE within the collection of UEs related to the specific application.

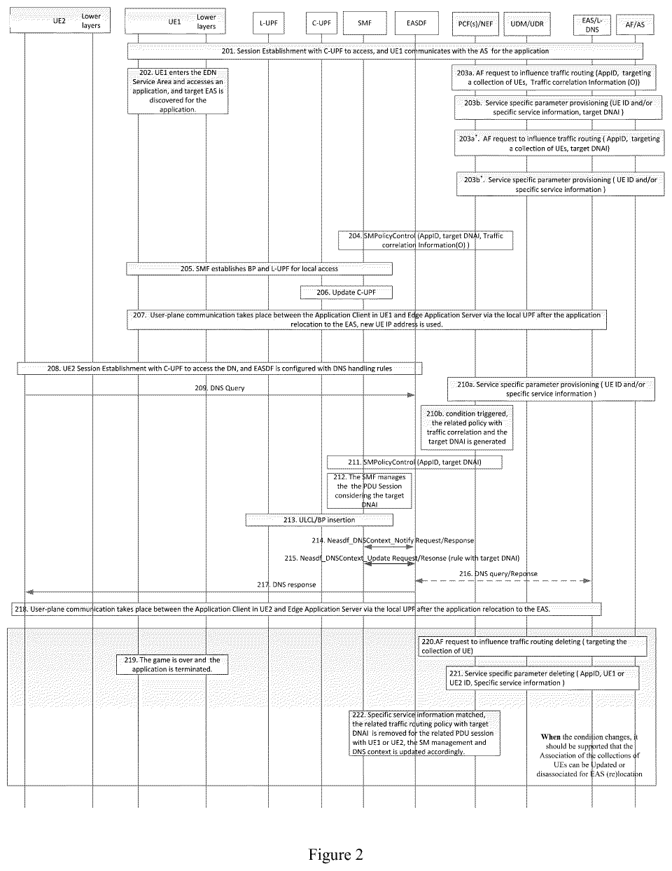

A first embodiment relates to edge relocation with target DNAI being notified from AF to PCF. The detailed procedure of the first embodiment is described as follows with reference to FIG. 2.

In step 201, UE1 establishes a PDU session with C-UPF.

In step 202, UE1 enters EDN Service Area and accesses an application (e.g. initiates a game). A target EAS is discovered for the application. For example, the target EAS is associated with a DNAI (e.g. accessed from the DNAI).

In addition to UE1, other UEs accessing the application (e.g. the UEs joining the game) will be required to be served by the server (e.g. target EAS or other EAS) associated with the same DNAI, which can be referred to as target DNAI. The target DNAI is an example of dedicated relocation information. Incidentally, if there is more than one server for the application associated with the DNAI, the UEs accessing the application can be served by the more than one server associated with the DNAI.

In step 203, the dedicated relocation information (i.e. target DNAI) is sent to PCF. Step 203 can be implemented as steps 203a and 203b.

In step 203a, an AF request to influence traffic routing is sent to PCF.

The AF request is for a specific application (e.g. the application accessed by UE1). The specific application may be identified by an application ID (AppID).

The AF request targets a collection of UEs. The collection of UEs can be identified by a group ID which identifies a group of UEs, wherein, the group of UEs can be pre-configured in the core network or dynamically managed with the existing mechanism. Alternatively, the collection of UEs can be identified by service information of UE. The UEs share the same service information can be treated as the collection of UEs. For the example of UEs in the same match, the service information of a target UE can be an application instance identifier identifying the application instance of the specific application which for example can be the identifier (e.g. the code or name) of the game for the application. The target UE belongs to the collection of UEs within the same match. For other examples, it is based on the implementation for how to describe the shared service information for associating the collection of UEs sharing the same service information. It means that each UE belonging to the collection of UEs contains, in the service information (maybe referred to as specific service information), the application instance identifier identifying the application instance of the specific application. It can be stated that each of the collection of UEs contains specific service information.

The AF request may contain traffic correlation indication, which means that the traffic of the collection of UEs related to the specific application should be correlated. The collection of UEs, identified either by the group ID or by the specific service information, shall apply the traffic correlation indication for the specific application, i.e. the traffic related to the specific application from the collection of UEs should be correlated, e.g. the traffic related to the specific application from the collection of UEs should be relocated to a target DNAI provided as dedicated relocation information in step 203b.

In step 203b, in a service specific parameter provisioning procedure, the dedicated relocation information (i.e. the target DNAI in the first embodiment) for the specific application for a specific UE (e.g. UE1) is sent to PCF. In addition, the UE ID and/or the specific service information, that is used to associate the UE to the collection of UEs, are also sent in the service specific parameter provisioning procedure.

The dedicated relocation information (i.e. the target DNAI) for the specific application targeting a specific UE can be determined as the dedicated relocation information (i.e. the target DNAI) for the specific application targeting a collection of UEs if the specific UE belongs to the collection of UEs.

If the collection of UEs is identified by the group ID, the UE (identified by UE ID) belonging to the group identified by the group ID determines that the specific UE belongs to the collection of UEs, and accordingly the dedicated relocation information (i.e. the target DNAI) contained in step 203b applies to the collection of UEs. Incidentally, if the collection of UEs is identified by a group ID and the group of UEs is pre-configured in the core network or are dynamically managed using the existing 5GVN group management mechanism, it is unnecessary to send the specific service information for the UE ID in step 203b. It means that only target DNAI for the UE and the traffic is sent in step 203b. On the other hand, if the collection of UEs share the same specific service information in the AF is identified by the group ID within the core network and the group of UEs is dynamically managed based on the specific service information, both the information for associating the UE to the collection of UE (e.g. the specific service information) and the dedicated relocation information (target DNAI) for the UE and the traffic are included in step 203b. The core network associates the UE with the collection of UEs for the specific application identified by a group ID within the core network.

Alternatively, if the collection of UEs is identified by the specific service information, the specific service information contained in step 203b matching the specific service information contained in step 203a determines that the specific UE belongs to the collection of UEs, and accordingly the dedicated relocation information (i.e. the target DNAI) contained in step 203b applies to the collection of UEs. It means that if the collection of UEs is identified by the specific service information, the specific service information is sent along with target DNAI for the traffic in step 203b, so that the core network knows that the target DNAI is for the specific application for the UEs having the specific service information. Optionally, the collection of UEs can be identified with the combination of specific service information and existing target UEs (e.g. group ID or any UE).

If the dedicated relocation information (i.e. the target DNAI) contained in step 203b applies to the collection of UEs, the dedicated relocation information (i.e. the target DNAI) shall be stored in UDR or PCF as associated data for the collection of UEs. If the related information in step 203b is received via the procedure with action of storing information within the UDR, the information is stored in the UDR for the UE and correlated with the collection of UEs and stored as associated data for the collection of UEs; or if the related information in step 203b is received via the procedure without action of storing information within the UDR, the information is stored in the PCF for the UE and correlated with the collection of UEs and stored as associated data for the collection of UEs in the PCF and maybe further stored in the UDR by the PCF for UEs within the collection using different PCFs to get the information.

The service specific parameter provisioning procedure of step 203b for delivering the dedicated relocation information to PCF can be from AF to PCF directly or indirectly (e.g. with NEF and/or UDR involved) by reusing one of the following procedures (1) to (3) with the additional information included:

(1) The procedure of Setting up an AF session with required QoS defined in 3GPP TS 23.502 clause 4.15.6.6;

(2) The procedure of Service specific parameter provisioning defined in 3GPP TS 23.502 clause 4.15.6.7; and

(3) The procedure of Application Function influence on traffic routing as defined in 3GPP TS 23.502 clause 4.3.6.4.

In addition, the service specific parameter provisioning procedure of step 203b may be implemented by a new procedure among AF and PCF, possibly with NEF and/or UDR involved.

Step 203 can be alternatively implemented as steps 203a′ and 203b′ (step 203b′ maybe an optional step).

In step 203a′, an AF request to influence traffic routing is sent to PCF. Similar to step 203a, the AF request is for a specific application, and targets a collection of UEs.

The AF request may contain the dedicated relocation information (i.e. the target DNAI in the first embodiment). It means that the dedicated relocation information (i.e. the target DNAI) for the specific application and targeting the collection of UEs is contained in the AF request to influence traffic routing.

For example, the dedicated relocation information (i.e. the target DNAI) can be indicated with DNAI with its N6 traffic routing information and relocation indication (which are existing information elements contained in the AF request indicating that the DNAI can be used for the traffic for a UE, and is reused to indicate the target DNAI for the collection of UEs). In this condition, only the target DNAI can be included as the dedicated relocation information for the specific application and targeting the collection of UEs. It means that the DNAI(s) indicating the possible application location(s) cannot be included in the AF request at the same time with the target DNAI.

Alternatively, if both the DNAI(s) indicating the possible application location(s) and the dedicated relocation information (e.g. target DNAI) for the specific application for targeting the collection of UEs are required to be contained in the AF request, the target DNAI shall be indicated using a new information element in the AF request that is specific for describing the target DNAI.

For the dedicated relocation information exemplified as target DNAI, it may include multiple DNAIs, for example, when the EAS may be accessed via different DNAIs or a group of DNAIs can be used to access the application by the collection of UEs.

The traffic correlation indication can be optionally included in the AF request in step 203a′. It means that, if the dedicated relocation information included in the AF request is regarded to implicitly indicate the traffic correlation indication, it is unnecessary to explicitly include the traffic correlation indication in the AF request. Otherwise, the AF request may explicitly include the traffic correlation indication which indicates that the traffic related to the specific application for the collection of UEs should be correlated, e.g. the traffic related to the specific application for the collection of UEs should be relocated to the target DNAI (i.e. the dedicated relocation information).

In an optional step 203b′, the information for associating the UE to the collection of UEs (e.g. the UE belongs to the collection of UEs) for the specific application is sent to PCF. If the collection of UEs is identified by a group ID and the group of UEs is pre-configured in the core network or dynamically managed using the existing 5GVN group management mechanism, step 203b′ is unnecessary. On the other hand, if the collection of UEs is identified by the group ID and the group of UEs is dynamically managed based on the specific service information, the information for associating the UE to the collection of UEs (e.g. the specific service information) for the UE and the traffic is included in step 203b′. The core network associates the UE with the collection of UEs for the specific application identified by a group ID within the core network. Alternatively, if the collection of UEs is identified by the specific service information, the specific service information to associate UE1 to the collection of UEs is included and sent to the PCF in step 203b′.

In step 204, the target DNAI for the specific application and targeting UE1 is sent to SMF as a part of PCC rule from PCF. Optionally, the traffic correlation indication for the specific application is also sent to SMF. If the traffic correlation indication for the specific application is also sent to SMF, all the PDU sessions with the same traffic correlation indication in the SMF can be correlated together to relocate the related traffic to the target DNAI.

Further, if the collection of UEs is identified by group ID, the group ID can be sent to SMF when SMF retrieves SM subscription data. The SMF, including the group ID, retrieves the PCC rule from PCF for each UE, or the PCC rule is updated and sent to the SMF.

Alternatively, if the dedicated relocation information is stored in the UDR as part for information for the collection of UEs, if the data of the collection of UEs is sent to the SMF as a whole, the dedicated relocation information can be included and stored in the SMF and used by any UE associated with the collection of UEs. The associating of a specific UE to the collection of UEs can be done based on the information described in the step 203b or 203b′. In this case, the dedicated relocation information is not included in the PCC rule. The associating of a specific UE to the collection of UEs can be performed in the PCF, UDR or SMF.

SMF manages the PDU Session (which includes the routing decisions for traffic of PDU Session and/or the DNS handling rule decision) considering the target DNAI for UE1. In steps 205 to 207, SMF controls traffic routing for UE1 based on the dedicated relocation information (the target DNAI) received in step 204. In step 205, BP and L-UPF are inserted for UE1 based on the dedicated relocation information (e.g. the target DNAI). In optional step 206, according to the dedicated relocation information (the target DNAI), C-UPF for UE1 may be updated. In step 207, user-plane communication takes place between the Application Client in UE1 and the application server associated with the target DNAI (e.g. the target EAS discovered in step 202). A new UE IP address is used for the traffic of UE1 to the application server associated with the target DNAI if multi-homing is used.

It is assumed that UE2 accesses the same match of the stateful online multiplayer game as UE1. It means that UE2 and UE1 shall access the specific application from the same server(s) (e.g. target EAS) within the same local part of DN, e.g. accessed from the same DNAI. For example, UE2 may be invited by UE1 to play the same match, or UE2 voluntarily plays the same match as UE1 by selecting the same match at AF.

In step 208, UE2 initiates session establishment with C-UPF to access the DN. EASDF is configured with DNS handling rules.

In step 209, UE2 sends DNS query for the specific application.

Step 210a, which is similar to step 203b′, is for the purpose of notifying PCF that UE2 belongs to the collection of UEs for the specific application. If the collection of UEs is identified by a group ID and the group of UEs is pre-configured in the core network or dynamically managed using the existing 5GVN group management mechanism (which means that PCF knows that UE2 belongs to the collection of UEs for the specific application), step 210a is unnecessary. On the other hand, if the collection of UEs is identified by the group ID and the group of UEs is dynamically managed based on the specific service information, the information for associating UE2 to the collection of UEs (e.g. the specific service information) for the UE and the traffic is included in step 210a. The core network associates the UE with the collection of UEs for the specific application identified by a group ID within the core network. Alternatively, if the collection of UEs is identified by the specific service information, the specific service information to associate UE2 to the collection of UEs is included and sent to the PCF in step 210a.

In step 210b, in PCF, a condition that UE2 belongs to the collection of UEs for the specific application in which UE1 is included is triggered. It means that (1) UE2 accessing the application belongs to the group ID associated with the target DNAI or (2) the service information of UE2 matches the specific service information for associating the collection of UEs associated with the target DNAI.

If the condition is triggered, the related policy with the target DNAI and optionally with traffic correlation indication for UE2 for the specific application is generated in PCF.

In step 211, the target DNAI for UE2 for the specific application is sent to SMF as a part of PCC rule from PCF. Optionally, the traffic correlation indication for UE2 for the specific application is also sent to SMF.

Alternatively, if the dedicated relocation information is stored for the collection of UEs and sent to the SMF, UE2 can use this dedicated relocation information as long as it is associated with the collection of UEs. In this case, the dedicated relocation information is not included in the PCC rule. The SMF gets the information on whether the UE2 is associated with the collection of UEs via associating of UE2 with the collection of UEs performed in the PCF, UDR or SMF based on information described in step 210a.

In step 212, SMF manages the PDU Session (which includes the routing decisions for traffic of PDU Session and/or the DNS handling rule decision) considering the target DNAI received from the PCF in step 211 for UE2. If the traffic correlation indication is sent to SMF, all the PDU sessions with the same traffic correlation indication in the SMF will be correlated together to relocate the related traffic to the target DNAI.

In optional step 213, ULCL and/or BP insertion are performed for UE2 for the specific application based on the target DNAI received in step 211.

In step 214, SMF receives the notification of DNS query message for UE2 for the specific application as described in step 209. In particular, if the DNS Query message matches a DNS message detection template of DNS message handling rule for reporting, the EASDF sends the DNS message report to SMF.

In step 215, If the DNS query sent in step 209 is notified from EASDF as described in step 209 after the target DNAI for UE2 for the specific application is received in SMF as described in step 211, the SMF decides the DNS handling rule for UE2 based on the target DNAI for UE2 received in step 211, including selecting the EDNS Client Subnet option or the local DNS server based on the target DNAI. The DNS handling rule including the information based on the target DNAI for UE2 is sent to EASDF.

In step 216, EASDF handles the DNS Query message based on the DNS handling rule received in step 215.

In step 217, EASDF sends the DNS response, i.e. the EAS(s) (e.g. the target BAS) within the same local part of DN as UE1 or associated with the target DNAI, to the UE2.

In step 218, user-plane communication takes place between the Application Client in UE2 and the EAS(s) associated with the target DNAI, via the local UPF after the application relocation to the EAS(s).

When the condition changes, the association of the collection of UEs with the dedicated relocation information for the specific application can be updated or disassociated. For example, the collection of UEs can be updated. For another example, the dedicated relocation information can be updated. For yet another example, the association of the collection of UEs with the dedicated relocation information for the specific application can be disassociated.

Steps 219 to 222 provide an example of disassociating the association of the collection of UEs when the game is over.

In step 219, the game is over. It means that the specific application instance shall be terminated.

In step 220, an AF request to influence traffic routing is sent to the core network (e.g. to PCF). The AF request targets a collection of UEs, identified by the group ID or specific service information. The AF request is for deleting the information with traffic correlation indication and the dedicated relocation information for the collection of UEs.

In an optional step 221, in a service specific parameter deleting procedure, the specific service information to associate UE1 or UE2 for the specific application is removed from the PCF. It notifies the PCF that UE1 or UE2 no longer belongs to the collection of UEs. If the collection of UEs is identified by a group ID and the group of UEs is pre-configured in the core network (which means that the core network knows that UE1 and UE2 belong to the collection of UEs for the specific application), step 221 is unnecessary and can be implemented using the existing mechanism to remove the UE from the group.

In step 222, the PCF makes the decision to modify the SM policy for the application within the PDU session accordingly. If the collection of UEs with the dedicated relocation information is updated, the AF update is executed and the PCF updates the related SM policy accordingly.

As a whole, in the first embodiment, the dedicated relocation information, which is the target DNAI, is sent to the PCF and then to SMF. So, a collection of UEs (e.g. UE1 and UE2) access the specific application via the same DNAI associated with the target server (or target application server) to access the application server(s) (e.g. the target server) within the same local part of DN.

According to the first embodiment, multi-homing or ULCL is used for local offload traffic. The target PSA is L-UPF selected based on the traffic routing information considering the dedicated relocation information (i.e. target DNAI). The central PSA is C-UPF. The Branch Point (BP)/ULCL UPF and L-UPF are established during local offloading of the PDU session considering the dedicated relocation information (i.e. target DNAI).

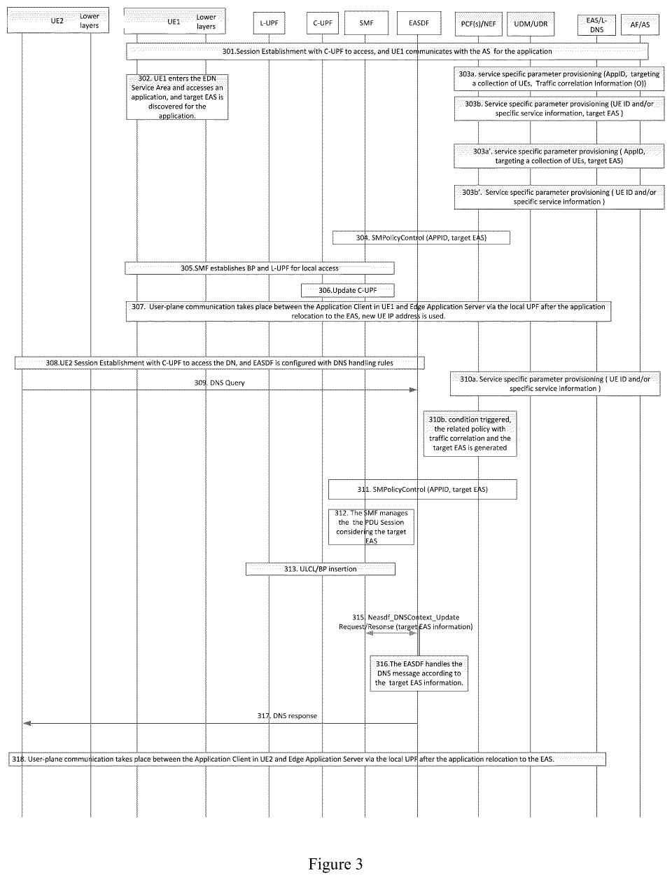

A second embodiment relates to edge relocation with target server (e.g. target EAS) being notified from AF to PCF. The detailed procedure of the second embodiment is described as follows with reference to FIG. 3. The target server can be referred to as target application server.

The second embodiment differs from the first embodiment mainly in that the dedicated relocation information is the target server instead of target DNAI.

In step 301, UE1 establishes a PDU session with C-UPF.

In step 302, UE1 enters EDN Service Area and access an application (e.g. initiates a game). A target EAS is discovered for the application.

In addition to UE1, other UEs accessing the application (e.g. the UEs joining the game) will be required to be served also by the target EAS. The target EAS is an example of dedicated relocation information.

In step 303, the dedicated relocation information (i.e. target EAS) is sent to PCF. Step 303 can be implemented as steps 303a and 303b.

In step 303a, an alternative implementation to step 203a is described, the procedure of service specific parameter provisioning defined in 3GPP TS 23.502 clause 4.15.6.7 is reused.

The service specific parameter provisioning is for a specific application (e.g. the application accessed by UE1). The specific application may be identified by an application ID (AppID).

The service specific parameter provisioning targets a collection of UES. Similar to the first embodiment, the collection of UEs can be identified by a group ID or service information of UE (specific service information).

In step 303b, in a service specific parameter provisioning procedure, the dedicated relocation information (i.e. the target EAS in the second embodiment) for the specific application for a specific UE (e.g. UE1) is sent to the PCF. In addition, the UE ID and/or the specific service information to associate UE1 to the collection of UEs are also sent in the service specific parameter provisioning procedure of step 303b. Similar to step 203b, if the collection of UEs is identified by a group ID and the group of UEs is pre-configured in the core network or is dynamically managed using the existing 5GVN group management mechanism, it is unnecessary to send the specific service information for the UE ID in step 303b.

Similar to the first embodiment, the dedicated relocation information (i.e. the target EAS) for the specific application targeting a specific UB can be determined as the dedicated relocation information (i.e. the target EAS) for the specific application targeting a collection of UEs if the specific UE (identified by UE ID and/or its specific service information) belongs to the collection of UEs.

Step 303 can be alternatively implemented as steps 303a′ and optionally 303b′.

In step 303a′, the target EAS, which is the dedicated relocation information, is sent to PCF in a service specific parameter provisioning for a specific application and targeting a collection of UEs.

In step 303b′, the information for associating the UE to the collection of UEs (e.g. the UE belongs to the collection of UEs) for the specific application is sent to PCF. If the collection of UEs is identified by a group ID and the group of UEs is pre-configured in the core network, step 303b′ is unnecessary. On the other hand, if the collection of UEs shares the same specific service information in the AF and is identified by the group ID within the core network and the group of UEs is dynamically managed based on the specific service information, the information for associating the UE to the collection of UE (e.g. the specific service information) for the UE and the traffic is included in step 303b′. The core network associates the UE with the collection of UEs for the specific application identified by a group ID within the core network. Alternatively, if the collection of UEs are identified by the specific service information, the specific service information to associate UE1 to the collection of UEs is included and sent to the PCF in step 303b′.

In step 304, the target EAS for the specific application and targeting a collection of UEs is sent to SMF as a part of PCC rule for UE1 from PCF.

SMF manages the PDU Session (which includes the routing decisions for traffic of PDU Session and/or the DNS handling rule decision) considering the target EAS for UE1. In steps 305 to 307, SMF controls traffic routing for UE1 based on the dedicated relocation information (the target EAS) received in step 304. In step 305, BP or ULCL and L-UPF are inserted for UE1 based on the dedicated relocation information (e.g. the target EAS). In optional step 306, according to the dedicated relocation information (the target EAS), C-UPF for UE1 may be updated. In step 307, user-plane communication takes place between the Application Client in UE1 and the application server (i.e. the target EAS). The PDU session with multiple PSAs is used for local offload traffic.

In step 308, UE2 initiates session establishment with C-UPF to access the DN. EASDF is configured with DNS handling rules.

In step 309, UE2 sends DNS query for the specific application.

Step 310a is the same as step 210a. In particular, step 310a is for the purpose of informing PCF that UE2 belongs to the collection of UEs for the specific application. If the collection of UEs is identified by a group ID and the group of UEs is pre-configured in the core network or dynamically managed using the existing 5GVN group management mechanism (which means that the core network knows that UE2 belongs to the collection of UEs for the specific application), step 310a is unnecessary. On the other hand, if the collection of UEs is identified by the group ID and the group of UEs is dynamically managed based on the specific service information, the information for associating the UE2 to the collection of UEs (e.g. the specific service information) for the UE and the traffic is included in step 310a. The core network associates the UE with the collection of UEs for the specific application identified by a group ID within the core network. Alternatively, if the collection of UEs is identified by the specific service information, the specific service information to associate UE2 to the collection of UEs is included and sent to the PCF in step 310a.

Step 310b is the same as step 210b, except that the target EAS replaces the target DNAI. In particular, a condition that UE2 belongs to the collection of UEs for the specific application in which UE1 is included is triggered. It means that (1) UE2 accessing the application belongs to the group ID associated with the target EAS or (2) the service information of UE2 matches the specific service information for associating the collection of UEs associated with the target EAS. If the condition is triggered, the related policy with the target EAS and optionally with traffic correlation indication for UE2 for the specific application is generated in PCF.

In step 311, the target EAS for UE2 for the specific application is sent to SMF from PCF.

In step 312, SMF manages the PDU Session (which includes the routing decisions for traffic of PDU Session and/or the DNS handling rule decision) considering the target EAS for UE2 received from the PCF in step 311.

In optional step 313, ULCL and/or BP insertion are performed for UE2 for the specific application based on the target EAS received in step 311.

In step 315, if the DNS query sent in step 309 is notified from EASDF as described in step 309 after the target EAS for UE2 for the specific application is received in SMF as described in step 311, the SMF decides the DNS handling rule based on the target EAS for UE2 received in step 311. For example, one action of responding with the target EAS is configured to EASDF.

In step 316, EASDF handles the DNS Query message based on the DNS handling rule received in step 315.

In step 317, the EASDF sends the DNS response, i.e. with the target EAS, to the UE.

In step 318, user-plane communication takes place between the Application Client in UE2 and the target EAS.

When the condition changes, the association of the collection of UEs with the dedicated relocation information for the specific application can be updated or disassociated, e.g. by referring to steps 219 to 222.

As a whole, in the second embodiment, the dedicated relocation information, which is the target EAS, is sent to the PCF and then to SMF. So, a collection of UEs access the specific application via the same EAS.

According to the second embodiment, PDU session with multiple PSAs is used for local offload traffic using either multihoming (BP is used) or ULCL.

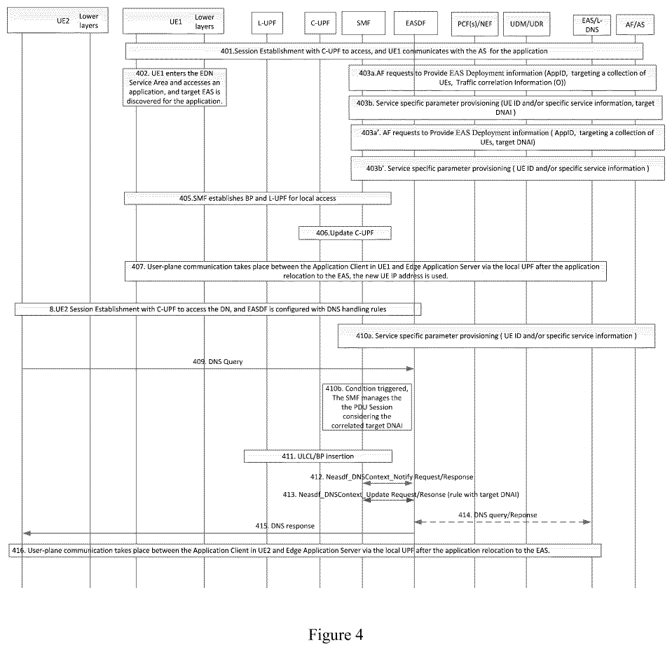

A third embodiment relates to edge relocation with target DNAI being notified from AF to SMF. The detailed procedure of the third embodiment is described as follows with reference to FIG. 4.

In step 401, UE1 establishes a PDU session with C-UPF.

In step 402, UE1 enters EDN Service Area and access an application (e.g. initiates a game). A target EAS is discovered for the application. For example, the target EAS is associated with a DNAI (e.g. accessed from the DNAI).

In addition to UE1, other UEs accessing the application (e.g. the UEs joining the game) will be required to be served by the server (e.g. the target EAS or other EAS) associated with the same DNAI, which can be referred to as target DNAI. The target DNAI is an example of dedicated relocation information. If there is more than one server for the application associated with the DNAI, the UEs accessing the application can be served by the more than one server associated with the DNAI.

In step 403, the dedicated relocation information (i.e. target DNAI) is sent to SMF. Step 403 can be implemented as steps 403a and 403b.

In step 403a, an AF request to provide EAS Deployment information is sent to SMF by reusing the procedure as defined in 3GPP TS 23.548 clause 6.2.3.4 with some update. The related procedures are defined for EAS Deployment Information management.

The AF request is for a specific application (e.g. the application accessed by UE1). The specific application may be identified by an application ID (AppID).

The AF request targets a collection of UEs. Similar to the first embodiment, the collection of UEs can be identified by a group ID or service information of UE (specific service information).

The AF request may contain traffic correlation indication.

In step 403b, in a service specific parameter provisioning procedure, the dedicated relocation information (i.e. the target DNAI in the third embodiment) for the specific application for a specific UE (e.g. UE1) is sent to the SMF (e.g. informed from the AF, stored in the UDR and notified to the SMF directly or sent to the SMF via policy information from the PCF).

Similar to the first embodiment, the dedicated relocation information (i.e. the target DNAI) for the specific application targeting a specific UE can be determined as the dedicated relocation information (i.e. the target DNAI) for the specific application targeting a collection of UEs if the specific UE belongs to the collection of UEs.

If the dedicated relocation information (i.e. the target DNAI) contained in step 403b applies to the collection of UEs, the dedicated relocation information (i.e. the target DNAI) shall be stored, e.g. in UDR by the SMF or in SMF, as associated data for the collection of UEs.

The service specific parameter provisioning procedure of step 403b for delivering the dedicated relocation information to SMF may reuse one of the following procedures (1) to (4) with the additional information included:

(1) The procedure of NEF service operations information flow defined in GPP TS 23.502 clause 4.15.6.2.

(2) The procedure of Setting up an AF session with required QoS defined in 3GPP TS 23.502 clause 4.15.6.6;

(3) The procedure of Service specific parameter provisioning defined in 3GPP TS 23.502 clause 4.15.6.7;

(4) The procedure of Application Function influence on traffic routing as defined in 3GPP TS 23.502 clause 4.3.6.4.

Step 403 can be alternatively implemented as steps 403a′ and optionally 403b′.

In step 403a′, an AF request to provide EAS Deployment information is sent to SMF. Similar to step 403a, the AF request is for a specific application, and targets a collection of UEs.

The AF request may contain the dedicated relocation information (i.e. the target DNAI in the third embodiment). It means that the dedicated relocation information (i.e. the target DNAI) for the specific application and targeting the collection of UEs is contained in the AF request to provide EAS Deployment information.

For example, the dedicated relocation information (i.e. the target DNAI) can be indicated with DNAI and optionally with relocation indication. In this condition, the target DNAI can be included as the dedicated relocation information for the specific application and targeting the collection of UEs.

For the dedicated relocation information exemplified as target DNAI, it may include multiple DNAIs, for example, when the EAS may be accessed via different DNAIs or a group of DNAIs can be used to access the application by the collection of UEs.

The traffic correlation indication can be optionally included in the AF request in step 403a′. It means that, if the dedicated relocation information included in the AF request is regarded to implicitly indicate the traffic correlation indication, it is unnecessary to explicitly include the traffic correlation indication in the AF request. Otherwise, the AF request may explicitly include the traffic correlation indication which indicates that the traffic related to the specific application from the collection of UEs should be correlated, e.g. the traffic related to the specific application from the collection of UEs should be relocated to the target DNAI (i.e. the dedicated relocation information).

In an optional step 403b′, the information to associate the UE to the collection of UEs (e.g. the UE belongs to the collection of UEs) for the specific application is sent to SMF. If the collection of UEs is identified by a group ID and the group of UEs is pre-configured in the core network or dynamically managed using the existing 5GVN group management mechanism, step 403b′ is unnecessary. On the other hand, if the collection of UEs is identified by the group ID and the group of UEs is dynamically managed based on the specific service information, the information for associating the UE to the collection of UEs (e.g. the specific service information) for the UE and the traffic is included in the message sent from the AF in step 403b′. The core network associates the UE with the collection of UEs for the specific application identified by a group ID within the core network. The subscription data of UE1 may be updated with the associated group ID. Alternatively, if the collection of UEs is identified by the specific service information, the specific service information to associate UE1 to the collection of UEs is included and sent to the SMF in step 203b′. The information for associating the UE to the collection of UEs (e.g. the specific service information) for the UE may be implemented as one kind of traffic correlation indication information.

In steps 405 to 407, SMF controls traffic routing for UE1 based on the dedicated relocation information (the target DNAI) received in step 403b or 403a′. In step 405, BP/ULCL and L-UPF are inserted for UE1 based on the dedicated relocation information (e.g. the target DNAI). In optional step 406, according to the dedicated relocation information (the target DNAI), C-UPF for UE1 may be updated. In step 407, user-plane communication takes place between the Application Client in UE1 and the application server associated with the target DNAI (i.e. the target EAS discovered in step 402). A new UE IP address is used for the traffic of UE1 to the application server associated with the target DNAI if multi-homing is used.

In step 408, UE2 initiates session establishment with C-UPF to access the DN. EASDF is configured with DNS handling rules.

In step 409, UE2 sends DNS query for the specific application.

Step 410a, which is similar to step 403b′, is for the purpose of sending SMF the information that UE2 belongs to the collection of UEs for the specific application. If the collection of UEs is identified by a group ID and the group of UEs is pre-configured in the core network or dynamically managed using the existing 5GVN group management mechanism (which means that the core network knows that UE2 belongs to the collection of UEs for the specific application), step 410a is unnecessary. On the other hand, if the collection of UEs is identified by the group ID and the group of UEs is dynamically managed based on the specific service information, the information for associating the UE2 to the collection of UEs (e.g. the specific service information) for the UE and the traffic is included in step 410a. The core network associates the UE with the collection of UEs for the specific application identified by a group ID within the core network. The subscription data of UE1 may be updated with the associated group ID. Alternatively, if the collection of UEs is identified by the specific service information, the specific service information to associate UE1 to the collection of UEs is included and sent to the SMF in step 410a.

In step 410b, in SMF, a condition that UE2 belongs to the collection of UEs for the specific application in which UE1 is included is triggered. It means that (1) UE2 accessing the application belongs to the group ID associated with the target DNAI or (2) the service information of UE2 matches the specific service information for associating the collection of UEs associated with the target DNAI.

The SMF manages the PDU Session considering the target DNAI, which includes the routing decisions for traffic of PDU Session and/or the DNS handling rule decision.

In optional step 411, ULCL and/or BP insertion are performed for UE2 for the specific application based on the target DNAI.

In step 412, SMF receives the notification of DNS query message for UE2 for the specific application as described in step 409. In particular, if the DNS Query message matches a DNS message detection template of DNS message handling rule for reporting, EASDF sends the DNS message report to SMF.

In step 413, if the DNS query sent in step 409 is notified from EASDF as described in step 412 after the target DNAI for UE2 for the specific application is received in SMF as described in step 403b or 403a′, the SMF decides the DNS handling rule for UE2 based on the received target DNAI, including selecting the EDNS Client Subnet option or the local DNS server based on the target DNAI. The DNS handling rule including the information based on the target DNAI for UE2 is sent to EASDF.

In step 414, the EASDF handles the DNS Query message based on the DNS handling rule received in step 413.

In step 415, the EASDF sends the DNS response, i.e. the EAS(s) (e.g. the target EAS) within the same local part of DN as UE1 or associated with the target DNAI, to the UE.

In step 416, user-plane communication takes place between the Application Client in UE2 and the EAS(s) associated with the target DNAI, via the local UPF after the application relocation to the EAS(s).

As a whole, in the third embodiment, the dedicated relocation information, which is the target DNAI, is sent to SMF. So, a collection of UEs (e.g. UE1 and UE2) access the specific application via the same DNAI associated with the target server to access the application server(s) (e.g. the target server) within the same local part of DN.

According to the third embodiment, multi-homing is used for local offload traffic.

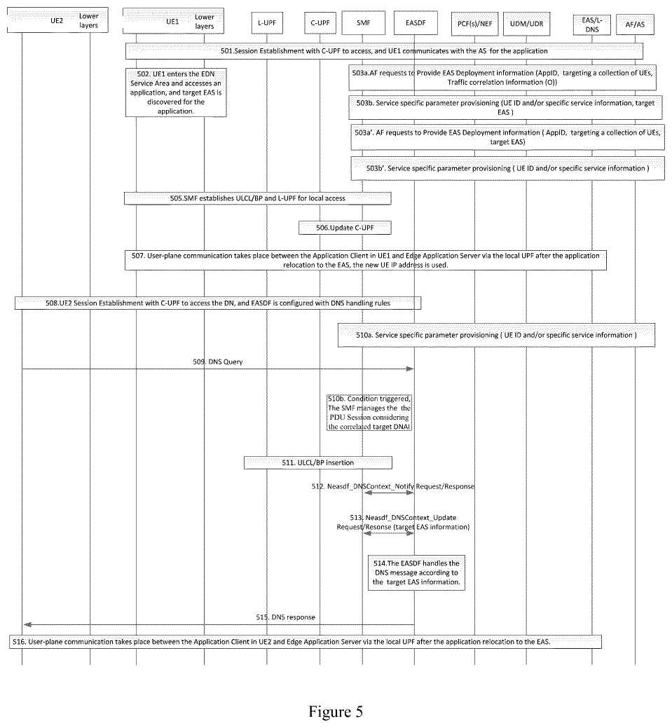

A fourth embodiment relates to edge relocation with target EAS being notified from AF to SMF. The detailed procedure of the fourth embodiment is described as follows with reference to FIG. 5.

The fourth embodiment differs from the third embodiment mainly in that the dedicated relocation information is the target EAS instead of target DNAI.

In step 501, UE1 establishes a PDU session with C-UPF.

In step 502, UE1 enters EDN Service Area and access an application (e.g. initiates a game). A target EAS is discovered for the application.

In addition to UE1, other UEs accessing the application (e.g. the UEs joining the game) will be required to be served also by the target BAS. The target EAS is an example of dedicated relocation information.

In step 503, the dedicated relocation information (i.e. target EAS) is sent to SMF. Step 503 can be implemented as steps 503a and 503b.

In step 503a, an AF request to provide EAS Deployment information is sent to SMF by reusing the procedure as defined in 3GPP TS 23.548 clause 6.2.3.4 with some update.

The AF request is for a specific application (e.g. the application accessed by UE1). The specific application may be identified by an application ID (AppID).

The AF request targets a collection of UEs. Similar to the first to the third embodiments, the collection of UEs can be identified by a group ID or service information of UE (specific service information).

In step 503b, in a service specific parameter provisioning procedure, the dedicated relocation information (i.e. the target EAS in the fourth embodiment) for the specific application for a specific UE (e.g. UE1) is sent to the SMF (e.g. informed from the AF, stored in the UDR and notified to the SMF directly or sent to the SMF via PCF).

Similar to the third embodiment, the dedicated relocation information (i.e. the target EAS) for the specific application targeting a specific UE can be determined as the dedicated relocation information (i.e. the target EAS) for the specific application targeting a collection of UEs if the specific UE belongs to the collection of UEs.

If the dedicated relocation information (i.e. the target EAS) contained in step 503b applies to the collection of UEs, the dedicated relocation information (i.e. the target DNAI) shall be stored, e.g. in UDR by the SMF or in SMF, as associated data for the collection of UEs. Step 503 can be alternatively implemented as steps 503a′ and optionally 503b′.

In step 503a′, an AF request to provide EAS Deployment information is sent to SMF. Similar to stop 503a, the AF request is for a specific application, and targets a collection of UEs.

The AF request may contain the dedicated relocation information (i.e. the target EAS in the fourth embodiment). It means that the dedicated relocation information (i.e. the target EAS) for the specific application and targeting the collection of UEs is contained in the AF request to provide EAS Deployment information.

In step 503b′, the information for associating the UE to the collection of UEs (e.g. the UE belongs to the collection of UEs) for the specific application is sent to SMF. If the collection of UEs is identified by a group ID and the group of UEs is pre-configured in the core network or dynamically managed using the existing SGVN group management mechanism, step 503b′ is unnecessary. On the other hand, if the collection of UEs is identified by the group ID and the group of UEs is dynamically managed based on the specific service information, the information for associating the UE to the collection of UEs (e.g. the specific service information) for the UE and the traffic is included in step 503b′. The core network associates the UE with the collection of UEs for the specific application identified by a group ID within the core network, the subscription data of UE1 may be updated with the associated group ID. Alternatively, if the collection of UEs is identified by the specific service information, the specific service information is to associate UE1 to the collection of UEs is sent to the SMF in step 503b′.

In steps 505 to 507, SMF controls traffic routing based on the dedicated relocation information (the target EAS) received in step 503b or 503a′. In step 505, BP and L-UPF are inserted for UE1 based on the dedicated relocation information (e.g. the target EAS). In optional step 506, according to the dedicated relocation information (the target EAS), C-UPF for UE1 may be updated. In step 507, user-plane communication takes place between the Application Client in UE1 and the application server (i.e. the target EAS). The PDU session with multiple PSAs is used for local offload traffic.

In step 508, UE2 initiates session establishment with C-UPF to access the DN. EASDF is configured with DNS handling rules.

In step 509, UE2 sends DNS query for the specific application.

Step 510a, which is similar to step 503b′, is for the purpose of sending SMF the information that UE2 belongs to the collection of UEs for the specific application. If the collection of UEs is identified by a group ID and the group of UEs is pre-configured in the core network or dynamically managed using the existing 5GVN group management mechanism (which means that the core network knows that UE2 belongs to the collection of UEs for the specific application), step 510a is unnecessary. On the other hand, if the collection of UEs is identified by the group ID and the group of UEs is dynamically managed based on the specific service information, the information for associating the UE2 to the collection of UEs (e.g. the specific service information) for the UE and the traffic is included in step 510a. The core network associates the UE with the collection of UEs for the specific application identified by a group ID within the core network, the subscription data of UE1 may be updated with the associated group ID. Alternatively, if the collection of UEs is identified by the specific service information, the specific service information to associate UE2 to the collection of UEs is included and sent to the SMF in step 510a.

In step 510b, in SMF, a condition that UE2 belongs to the collection of UEs for the specific application in which UE1 is included is triggered. It means that (1) UE2 accessing the application belongs to the group ID associated with the target EAS or (2) the service information of UE2 matches the specific service information for associating the collection of UEs associated with the target EAS.

The SMF manages the PDU Session considering the target EAS, which includes the routing decisions for traffic of PDU Session and/or the DNS handling rule decision.

In optional step 511, ULCL and/or BP insertion are performed for UE2 for the specific application based on the target EAS.

In step 512, SMF receives the notification of DNS query message for UE2 for the specific application as described in step 509. In particular, if the DNS Query message matches a DNS message detection template of DNS message handling rule for reporting, EASDF sends the DNS message report to SMF.

In step 513, if the DNS query sent in step 509 is notified from EASDF as described in step 512 after the target EAS for UE2 for the specific application is decided based on the target EAS received in SMF as described in step 503b or 503a′ and that the UE2 is associated with the collection of UEs, the SMF decides the DNS handling rule based on the target EAS, including selecting the EDNS Client Subnet option or the local DNS server based on the target EAS. The DNS handling rule including information based on the target EAS for UE2 is sent to EASDF.

In step 514, the EASDF handles the DNS Query message based on the DNS handling rule received in step 513.

In step 515, the EASDF sends the DNS response, i.e. the target EAS, to the UE.

In step 516, user-plane communication takes place between the Application Client in UE2 and the target EAS.

As a whole, in the fourth embodiment, the dedicated relocation information, which is the target EAS, is sent to SMF. So, a collection of UEs access the specific application via the same EAS.

According to the fourth embodiment, PDU session with multiple PSAs is used for local offload traffic.

In the above-described first embodiment and third embodiment, the target servers within a local part of DN are associated with one DNAI. It is possible that the target servers within a local part of DN are associated with more than one DNAI.

In the above embodiments, all of the network functions, including but not limited to AF, PCF, SMF and UDR, are named as in 5G system. These network functions are not limited to the network functions defined in 5G system. It means that network functions with the same or similar function(s) but having other names in other standard(s) are also covered in this specification. For example, a function that has the function of policy controlling is covered in this specification. For another example, a function that has the function of session management is also covered in this specification. For another example, a function that has the function of interacting with the core network in order to provide services is covered in this specification.

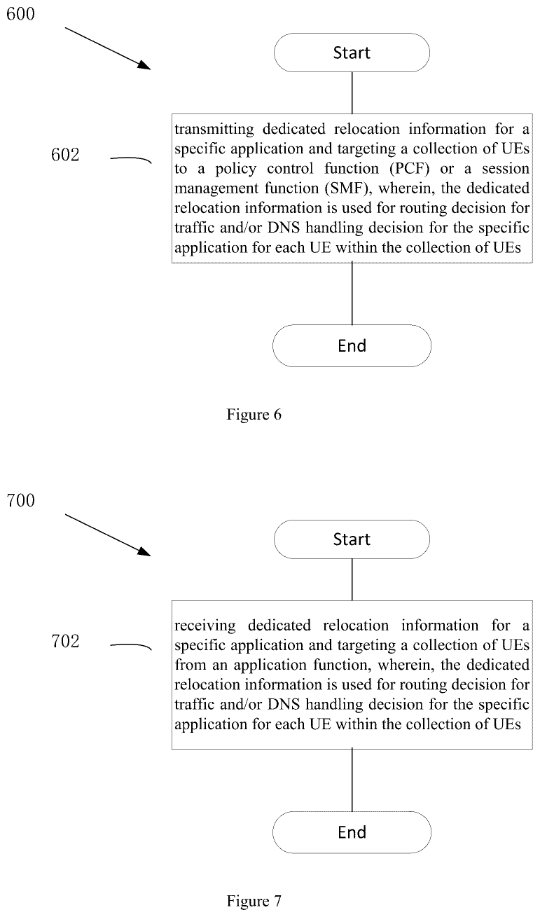

FIG. 6 is a schematic flow chart diagram illustrating an embodiment of a method 600 according to the present application. In some embodiments, the method 600 is performed by an application server (e.g. AF), In certain embodiments, the method 600 may be performed by a processor executing program code, for example, a microcontroller, a microprocessor, a CPU, a GPU, an auxiliary processing unit, a FPGA, or the like.

The method 600 may comprise 602 transmitting dedicated relocation information for a specific application and targeting a collection of UEs to a policy control function (PCF) or a session management function (SMF), wherein, the dedicated relocation information is used for routing decision for traffic and/or DNS handling decision for the specific application for each UE within the collection of UEs.

In some embodiment, the dedicated relocation information is a target data network access identifier (DNAI) or a target application server.

In some embodiment, the method 600 comprises transmitting the dedicated relocation information to SMF using a procedure for EAS deployment information management per node.

In some embodiment, the method 600 comprises transmitting a group ID or specific service information to identify the collection of UEs for the specific application, and transmitting the dedicated relocation information for a specific UE belonging to the collection of UEs.

In some embodiment, the method 600 comprises transmitting a group ID or specific service information to identify the collection of UEs, and the dedicated relocation information for the application and targeting the collection of UEs.

FIG. 7 is a schematic flow chart diagram illustrating an embodiment of a method 700 according to the present application. In some embodiments, the method 700 is performed by a policy control function (e.g. PCF). In certain embodiments, the method 700 may be performed by a processor executing program code, for example, a microcontroller, a microprocessor, a CPU, a GPU, an auxiliary processing unit, a FPGA, or the like.

The method 700 may comprise 702 receiving dedicated relocation information for a specific application and targeting a collection of UEs from an application function, wherein, the dedicated relocation information is used for routing decision for traffic and/or DNS handling decision for the specific application for each UE within the collection of UEs.

In some embodiment, the method 700 comprises transmitting the dedicated relocation information for the specific application and targeting a specific UE belonging to the collection of UEs to a session management function by using a policy and charging control rule.

In some embodiment, the method 700 comprises receiving a group ID or specific service information to identify the collection of UEs, and receiving the dedicated relocation information for a specific UE belonging to the collection of UEs.

In some embodiment, the method 700 comprises receiving a group ID or specific service information to identify the collection of UEs, and the dedicated relocation information for the application and targeting the collection of UEs.

In some embodiment, the dedicated relocation information is a target data network access identifier (DNAI) or a target application server.

In some embodiment, the method further comprises determining that a UE belongs to the collection of UEs if the UE is within a group of UEs identified by a predetermined group ID, or the UE is within a group of UEs sharing the same specific service information.

In some embodiment, the method further comprises storing the dedicated relocation information in the policy control function (e.g. PCF) or a unified data repository (e.g. UDR).

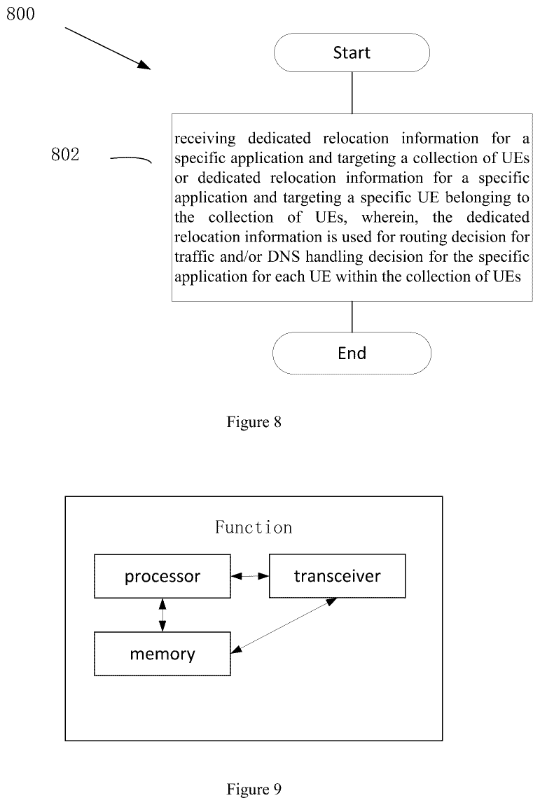

FIG. 8 is a schematic flow chart diagram illustrating an embodiment of a method 800 according to the present application. In some embodiments, the method 800 is performed by a session management function (e.g. SMF). In certain embodiments, the method 800 may be performed by a processor executing program code, for example, a microcontroller, a microprocessor, a CPU, a GPU, an auxiliary processing unit, a FPGA, or the like.

The method 800 may comprise 802 receiving dedicated relocation information for a specific application and targeting a collection of UEs or dedicated relocation information for a specific application and targeting a specific UE belonging to the collection of UEs, wherein, the dedicated relocation information is used for routing decision for traffic and/or DNS handling decision for the specific application for each UE within the collection of UEs.

In some embodiment, the method 800 comprises controlling traffic routing and/or Domain Name System (DNS) handling decision for UEs belonging to the collection of UEs according to the dedicated relocation information. In particular, controlling traffic routing comprises at least one of inserting a branching point (e.g. BP) and a user plane function (e.g. L-UPF) and updating a central user plane function (e.g. C-UPF).

In some embodiment, the dedicated relocation information for the specific application and targeting a collection of UEs is received from an application function using a procedure for EAS deployment information management per node.

In some embodiment, the dedicated relocation information for the specific application and targeting the specific UE is received from a policy control function using a policy and charging control rule.

In some embodiment, the method 800 further comprises determining that a UE belongs to the collection of UEs if the UE is within a group of UEs identified by a predetermined group ID, or the UE is within a group of UEs sharing the same specific service information.

In some embodiment, the method 800 further comprises storing the dedicated relocation information in the session management function or a unified data repository (e.g. UDR).

FIG. 9 is a schematic block diagram illustrating apparatuses according to one embodiment.

Referring to FIG. 9, the function includes a processor, a memory, and a transceiver. The processor implements a function, a process, and/or a method which are proposed in FIG. 6, or FIG. 7, or FIG. 8.

The function implementing the method of FIG. 6 may be an application function (e.g. AF), which comprises a transceiver; and a processor coupled to the transceiver, wherein the processor is configured to transmit, via the transceiver, dedicated relocation information for a specific application and targeting a collection of user equipments (UEs), to a policy control function or a session management function, wherein, the dedicated relocation information is used for routing decision for traffic and/or DNS handling decision for the specific application for each UE within the collection of UEs.

In some embodiment, the dedicated relocation information is a target data network access identifier (DNAI) or a target application server.

In some embodiment, the dedicated relocation information is transmitted to the session management function using a procedure for EAS deployment information management per node.

In some embodiment, the processor is configured to transmit, via the transceiver, a group ID or specific service information to identify the collection of UEs for the specific application, and transmit, via the transceiver, the dedicated relocation information for a specific UE belonging to the collection of UEs.

In some embodiment, the processor is configured to transmit, via the transceiver, a group ID or specific service information to identify the collection of UEs, and the dedicated relocation information for the application and targeting the collection of UEs.

The function implementing the method of FIG. 7 may be a policy control function (e.g. PCF), which comprises a transceiver; and a processor coupled to the transceiver, wherein the processor is configured to receive, via the transceiver, dedicated relocation information for a specific application and targeting a collection of UEs, from an application function, wherein, the dedicated relocation information is used for routing decision for traffic and/or DNS handling decision for the specific application for each UE within the collection of UEs.

In some embodiment, the processor is further configured to transmit, via the transceiver, the dedicated relocation information for the specific application and targeting a specific UE belonging to the collection of UEs to a session management function by using a policy and charging control rule.

In some embodiment, the processor is configured to receive, via the transceiver, a group ID or specific service information to identify the collection of UEs, and receive, via the transceiver, the dedicated relocation information for a specific UE belonging to the collection of UEs.

In some embodiment, the processor is configured to receive, via the transceiver, a group ID or specific service information to identify the collection of UEs, and the dedicated relocation information for the application and targeting the collection of UEs.

In some embodiment, the dedicated relocation information is a target data network access identifier (DNAI) or a target application server.

In some embodiment, the processor is further configured to determine that a UE belongs to the collection of UEs if the UE is within a group of UEs identified by a predetermined group ID, or the UE is within a group of UEs sharing the same specific service information.

In some embodiment, the processor is further configured to store the dedicated relocation information in the policy control function or a unified data repository (e.g. UDR).

The function implementing the method of FIG. 8 may be a session management function (e.g. SMF), which comprises a transceiver; and a processor coupled to the transceiver, wherein the processor is configured to receive, via the transceiver, dedicated relocation information for a specific application and targeting a collection of UEs or dedicated relocation information for a specific application and targeting a specific UE belonging to the collection of UEs, wherein, the dedicated relocation information is used for routing decision for traffic and/or DNS handling decision for the specific application for each UE within the collection of UEs.

In some embodiment, the processor is further configured to control traffic routing and/or Domain Name System (DNS) handling decision for UEs belonging to the collection of UEs according to the dedicated relocation information.

In some embodiment, to control traffic routing comprises at least one of inserting a branching point (e.g. BP) and a user plane function (e.g. L-UPF) and updating a central user plane function (e.g. C-UPF).

In some embodiment, the dedicated relocation information for the specific application and targeting a collection of UEs is received from an application function using a procedure for EAS deployment information management per node.

In some embodiment, the dedicated relocation information for the specific application and targeting the specific UE is received from a policy control function using a policy and charging control rule.

In some embodiment, the processor is further configured to determine that a UE belongs to the collection of UEs if the UE is within a group of UEs identified by a predetermined group ID, or the UE is within a group of UEs sharing the same specific service information.

In some embodiment, the processor is further configured to store the dedicated relocation information in the session management function or a unified data repository.

Layers of a radio interface protocol may be implemented by the processors. The memories are connected with the processors to store various pieces of information for driving the processors. The transceivers are connected with the processors to transmit and/or receive message or information. Needless to say, the transceiver may be implemented as a transmitter to transmit the information and a receiver to receive the information.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. An apparatus for wireless communication, comprising:
at least one memory; and
at least one processor coupled with the at least one memory and configured to cause the apparatus to:
transmit, to a policy control function or a session management function, dedicated relocation information for a specific application and targeting a collection of user equipments (UEs), wherein
the dedicated relocation information is used for a routing decision for a traffic and/or a domain name system (DNS) handling decision for the specific application for each UE within the collection of UEs.

2. The apparatus of claim 1, wherein the dedicated relocation information is a target data network access identifier (DNAI) or a target application server.

3. The apparatus of claim 1, wherein the at least one processor is configured to cause the apparatus to transmit the dedicated relocation information using a procedure for edge application server (EAS) deployment information management per node.

4. The apparatus of claim 1, wherein the at least one processor is configured to;
transmit a group ID or specific service information to identify the collection of UEs for the specific application, and
transmit the dedicated relocation information for a specific UE belonging to the collection of UEs.

5. The apparatus of claim 1, wherein the at least one processor is configured to;
transmit a group ID or specific service information to identify the collection of UEs, and the dedicated relocation information for the application and targeting the collection of UEs.

6. An apparatus for wireless communication, comprising:
at least one memory; and
at least one processor coupled with the at least one memory and configured to cause the apparatus to:
receive, from an application function, dedicated relocation information for a specific application and targeting a collection of user equipments (UEs), wherein,
the dedicated relocation information is used for routing decision for a traffic and/or a domain name system (DNS) handling decision for the specific application for each UE within the collection of UEs.

7. The apparatus of claim 6, wherein the at least one processor is further configured to cause the apparatus to:
transmit the dedicated relocation information for the specific application and targeting a specific UE belonging to the collection of UEs to a session management function by using a policy and charging control rule.

8. The apparatus of claim 6, wherein the at least one processor is configured to cause the apparatus to:
receive a group ID or specific service information to identify the collection of UEs, and
receive the dedicated relocation information for a specific UE belonging to the collection of UEs.

9. The apparatus of claim 6, wherein the at least one processor is configured to cause the apparatus to:
receive a group ID or specific service information to identify the collection of UEs, and the dedicated relocation information for the application and targeting the collection of UEs.

10. The apparatus of claim 6, wherein the dedicated relocation information is a target data network access identifier (DNAI) or a target application server.

11. The apparatus of claim 6, wherein the at least one processor is further configured to cause the apparatus to determine that a UE belongs to the collection of UEs if the UE is within a group of UEs identified by a predetermined group ID, or the UE is within a group of UEs sharing a same specific service information.

12. An apparatus for wireless communication, comprising:
at least one memory; and
at least one processor coupled with the at least one memory and configured to cause the apparatus to:
receive dedicated relocation information for a specific application and targeting a collection of user equipments (UEs) or dedicated relocation information for a specific application and targeting a specific UE belonging to the collection of UEs, wherein
the dedicated relocation information is used for a routing decision for traffic and/or a domain name system (DNS) handling decision for the specific application for each UE within the collection of UEs.

13. The apparatus of claim 12, wherein the dedicated relocation information for the specific application and targeting the collection of UEs is received from an application function using a procedure for edge application server (EAS) deployment information management per node, or the dedicated relocation information for the specific application and targeting the specific UE is received from a policy control function using a policy control rule.

14. The apparatus of claim 12, wherein the at least one processor is further configured to cause the apparatus to determine that a UE belongs to the collection of UEs if the UE is within a group of UEs identified by a predetermined group ID, or the UE is within a group of UEs sharing a same specific service information.

15. The apparatus of claim 12, wherein the at least one processor is further configured to cause the apparatus to store the dedicated relocation information in a session management function or a unified data repository.

16. A method performed by an apparatus, the method comprising:
transmitting, to a policy control function or a session management function, dedicated relocation information for a specific application and targeting a collection of user equipments (UEs), wherein
the dedicated relocation information is used for a routing decision for a traffic and/or a domain name system (DNS) handling decision for the specific application for each UE within the collection of UEs.

17. The method of claim 16, wherein the dedicated relocation information is a target data network access identifier (DNAI) or a target application server.

18. The method of claim 16, wherein the transmitting comprises transmitting the dedicated relocation information using a procedure for edge application server (EAS) deployment information management per node.

19. The method of claim 16, further comprising:
transmitting a group ID or specific service information to identify the collection of UEs for the specific application, and
transmitting the dedicated relocation information for a specific UE belonging to the collection of UEs.

20. The method of claim 16, further comprising:
transmitting a group ID or specific service information to identify the collection of UEs, and the dedicated relocation information for the application and targeting the collection of UEs.
